(19) United States
(12) Patent Application Publication
(10) Pub. No.: US 2022/0100971 A1
(43) Pub. Date: Mar. 31, 2022

(54) DATA PROCESSING METHODS, MOBILE TERMINALS, AND OPEN PLATFORMS

(71) Applicant: Alipay Labs (Singapore) Pte. Ltd., Singapore (SG)

(72) Inventor: Xiaoliu Li, Hangzhou (CN)

(73) Assignee: Alipay Labs (Singapore) Pte. Ltd., Singapore (SG)

(21) Appl. No.: 17/350,532

(22) Filed: Jun. 17, 2021

(30) Foreign Application Priority Data
Sep. 25, 2020 (CN) 202011023466.5

(51) Int. Cl. G06F 40/58; G06F 40/30; G06F 40/51; G06F 40/263; G06F 40/42

(52) U.S. Cl. CPC G06F 40/58; G06F 40/30; G06F 40/42; G06F 40/263; G06F 40/51

(57) ABSTRACT

Disclosed herein are computer-implemented methods, systems, and media for data processing. One of the methods herein comprises: loading a first copywriting content expressed in a first form by calling a second computer program using a first interface of a first computer program, wherein the first computer program is installed on a mobile terminal and connected to a first server, and the second computer program accesses the first computer program using the first interface, and is connected to a second server, and wherein the second computer program downloads the first copywriting content from the second server; obtaining a second copywriting content with same semantics as the first copywriting content; replacing the first copywriting content with the second copywriting content, wherein the second copywriting content is expressed in a second form; and presenting the second copywriting content on the mobile terminal.

### CROSS-REFERENCE TO RELATED APPLICATIONS

This application claims priority to Chinese Patent Application No. 202011023466.5, filed on Sep. 25, 2020, which is hereby incorporated by reference in its entirety.

### TECHNICAL FIELD

The present application relates to the field of network data processing, and in particular, to data processing methods, mobile terminals, and open platforms.

### BACKGROUND

With the economic globalization, multi-language is a problem that needs to be handled for applications (APP).

Currently, there is no solution for multi-language problems of business services in APPs.

### SUMMARY

To solve the previous technical problem, the present application discloses data processing methods. The methods include: calling and running a second program by using a first interface on a first program, to load first copywriting content, where the first program is a main application running on a mobile terminal and is connected to a first server, the second program is an external application that accesses the first program by using the first interface, and the second program is connected to a second server and downloads the first copywriting content expressed in a first form from the second server; obtaining second copywriting content with the same semantics as the first copywriting content, and replacing the first copywriting content with the second copywriting content, where the second copywriting content is expressed in a second form; and displaying the second copywriting content.

In some embodiments, the first form includes a text expression in a first language, and the second form includes a text expression in a second language; and the displaying the second copywriting content includes: displaying, by the mobile terminal, the second copywriting content in a text form in the second language on a screen of the mobile terminal.

In some embodiments, the obtaining second copywriting content with the same semantics as the first copywriting content and replacing the first copywriting content with the second copywriting content includes: determining that a target language type is the second language; obtaining the first copywriting content; and obtaining the second copywriting content that is expressed in the second language and that corresponds to the first copywriting content.

In some embodiments, the determining that a target language type is the second language includes: determining, based on language setting information of the first program, that the target language type is the second language; determining, based on language setting information of the mobile terminal, that the target language type is the second language; or determining, based on location information of the mobile terminal, that the target language type is the second language.

In some embodiments, the obtaining the second copywriting content that is expressed in the second language and that corresponds to the first copywriting content includes: querying and obtaining, from at least one memory of the mobile terminal, the second copywriting content that is expressed in the second language and that corresponds to the first copywriting content.

In some embodiments, a target language pack is stored in the at least one memory, and the querying and obtaining, from at least one memory of the mobile terminal, the second copywriting content that is expressed in the second language and that corresponds to the first copywriting content includes: querying and obtaining, from the target language pack, the second copywriting content that is expressed in the second language and that corresponds to the first copywriting content.

In some embodiments, the data processing methods further include: requesting to obtain the target language pack from a language pack hosting platform, and receiving the target language pack from the language pack hosting platform.

In some embodiments, the obtaining the second copywriting content that is expressed in the second language and that corresponds to the first copywriting content includes: requesting a machine translation engine to translate the first copywriting content; and receiving, from the machine translation engine, the second copywriting content that is expressed in the second language and that corresponds to the first copywriting content.

In some embodiments, the data processing methods further include: storing the second copywriting content in at least one memory of the mobile terminal.

In some embodiments, the first form includes an audio expression in a first language, and the second form includes an audio expression in a second language. The displaying the second copywriting content includes: playing, by the mobile terminal, the second copywriting content in an audio form in the second language on a screen of the mobile terminal.

The present application further discloses mobile terminals. The mobile terminals include at least one memory storing at least one instruction set and at least one processor communicably coupled to the at least one memory. When the mobile terminal is running, the at least one processor reads and runs the at least one instruction set, and performs the data processing methods in the present application according to instructions of the at least one instruction set.

The present application further discloses open platforms. The open platforms include: a first interface, where the open platform can call and run a second program by using the first interface, the second program is an external application that accesses a first program by using the first interface, and the second program can be connected to a second server and download first copywriting content expressed in a first form from the second server; and a data processing component, configured to perform the following steps when the second program is running: The first copywriting content loaded by the second program is obtained, second copywriting content with the same semantics as the first copywriting content is obtained, and the first copywriting content is replaced with the second copywriting content, where the second copywriting content is expressed in a second form.

In some embodiments, the first form includes a text expression in a first language, and the second form includes a text expression in a second language.

In some embodiments, the obtaining second copywriting content with the same semantics as the first copywriting content and replacing the first copywriting content with the second copywriting content includes: determining that a target language type is the second language; and obtaining the second copywriting content that is expressed in the second language and that corresponds to the first copywriting content.

In some embodiments, the determining that a target language type is the second language includes: determining, based on language setting information of the open platform, that the target language type is the second language; determining, based on language setting information of a mobile terminal that the open platform is loaded in, that the target language type is the second language; or determining, based on location information of a mobile terminal that the open platform is loaded in, that the target language type is the second language.

In some embodiments, the obtaining the second copywriting content that is expressed in the second language and that corresponds to the first copywriting content includes: querying and obtaining, from at least one memory of a mobile terminal that the open platform is loaded in, the second copywriting content that is expressed in the second language and that corresponds to the first copywriting content.

In some embodiments, a target language pack is stored in the at least one memory, and the obtaining the second copywriting content that is expressed in the second language and that corresponds to the first copywriting content includes: querying and obtaining, from the target language pack, the second copywriting content that is expressed in the second language and that corresponds to the first copywriting content.

In some embodiments, the obtaining the second copywriting content that is expressed in the second language and that corresponds to the first copywriting content includes: requesting a machine translation engine to translate the first copywriting content; and receiving, from the machine translation engine, the second copywriting content that is expressed in the second language and that corresponds to the first copywriting content.

In some embodiments, the open platforms further include a second interface. When the second program that accesses the open platform is running, the open platform calls and runs the data processing component by using the second interface.

In conclusion, the present application provides data processing methods, open platforms, and mobile terminals installed with the open platforms. The open platform includes at least one first interface. The open platform can call and run a second program by using the at least one first interface. The open platform further includes a data processing component. When the second program is running, the data processing component can obtain first copywriting content that is expressed in a first form and that is loaded by the second program, obtain second copywriting content with the same semantics as the first copywriting content, and replace the first copywriting content with the second copywriting content, where the second copywriting content is expressed in a second form. The data processing component can obtain the second copywriting content from a local cache of the mobile terminal, a language pack, or a machine translation engine.

The data processing methods in the present application are used to implement multi-language for external applets and/or H5 pages, and development costs of developers on the applets and/or the H5 pages are low. A data processing component 700 can be used to translate applets and/or H5 pages, and can support translation of all applets and H5 pages. Merchants basically do not need to invest in multi-language development and operation and maintenance.

According to the data processing methods in the present application, for an update of static copywriting content, only the language pack needs to be updated. For dynamic long copywriting content, machine translation can be called. As such, investment in multi-language development for applets and/or H5 is reduced. For short copywriting content, a local cache or a language pack is directly used to implement translation, thereby avoiding a problem of low translation accuracy of machine translation for the short copywriting content.

According to the data processing methods in the present application, a data processing apparatus is integrated in a front end (that is, a mobile terminal side) of an open platform, and both extraction and replacement of copywriting content are performed on the front end side. Therefore, if a language type needs to be changed or a local language pack needs to be updated, the data processing apparatus only needs to request a server to update the language pack, and release is not needed, thereby reducing development costs. The data processing component in the present application can sense a copywriting content change and respond to the copywriting content change in time to trigger translation. According to the data processing methods in the present application, language packs and machine translation are combined, and advantages of the language packs and machine translation are used to solve the translation accuracy problem. According to the data processing methods in the present application, a hybrid mode is used, advantages of the front end and a native end are combined, and a translation speed and accuracy are well guaranteed, thereby improving performance experience of using applets/H5.

### BRIEF DESCRIPTION OF DRAWINGS

FIG. 1 illustrates an application scenario of a data processing method, according to some embodiments of the present application;

FIG. 2 is a schematic diagram illustrating a hardware structure of a mobile terminal, according to some embodiments of the present application;

FIG. 3 is a system block diagram illustrating an open platform, according to some embodiments of the present application;

FIG. 4A illustrates an interface displayed by a first program loaded in a mobile terminal, according to some embodiments of the present application;

FIG. 4B illustrates an interface of a second program, according to some embodiments of the present application; and

FIG. 5 is a flowchart illustrating a data processing method, according to some embodiments of the present application.

### DESCRIPTION OF EMBODIMENTS

The following description provides specific application scenarios and requirements of the present application, to enable a person skilled in the art to produce and use the content of the present application. For a person skilled in the art, various local modifications to the disclosed embodiments are obvious, and the general principles described here can be applied to other embodiments and applications without departing from the spirit and scope of the present application. Therefore, the present application is not limited to the described embodiments, but covers the widest scope consistent with the claims.

The terms used here are only for the purpose of describing specific example embodiments, and are not restrictive.

Considering the following description, these and other features of the present application, operations and functions of the related elements of the structure, and the combination of components and the economy of manufacturing can be significantly improved. All of these form a part of the present application with reference to the accompanying drawings. However, it should be clearly understood that the accompanying drawings are only for illustration and description purposes and are not intended to limit the scope of the present application.

The following description can significantly improve these and other features of the present application, operations and functions of the related elements of the structure, and the combination of components and the economy of manufacturing. All of these form a part of the present application with reference to the accompanying drawings. However, it should be clearly understood that the accompanying drawings are only for illustration and description purposes and are not intended to limit the scope of the present application. It should be further understood that the accompanying drawings are not to scale.

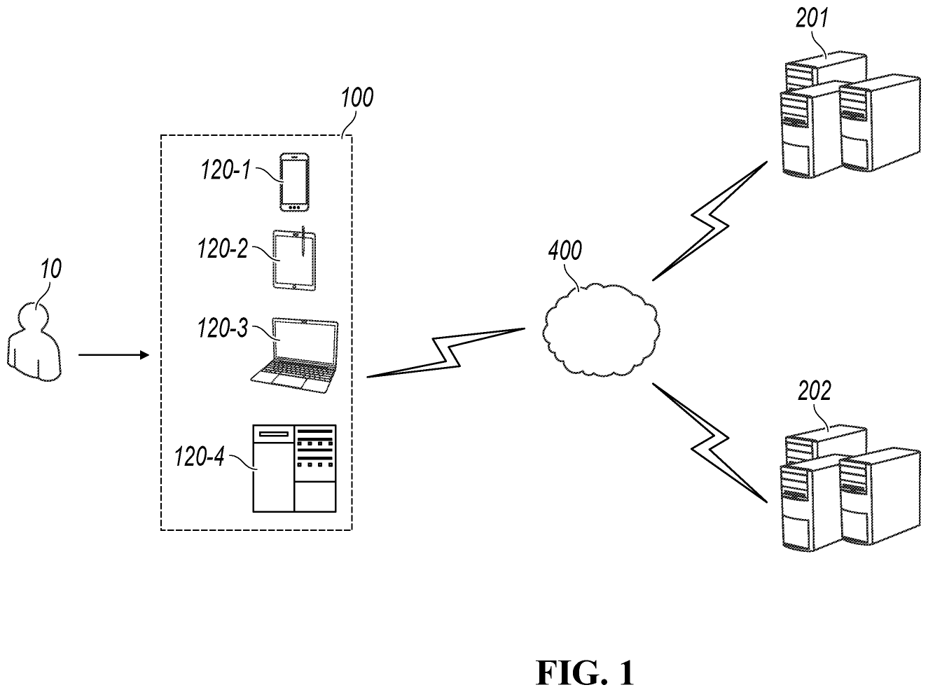

FIG. 1 illustrates an application scenario of a data processing method, according to some embodiments of the present application. The application scenario can include a mobile terminal 100, a first server 201, a second server 202, and a network 400.

The network 400 can facilitate exchange of information and/or data. As shown in FIG. 1, the mobile terminal 100 can be connected to the first server 201 and the second server 202 by using the network 400, and mutually transmit information and/or data by using the network 400. The network 400 can be any type of wired or wireless network or a combination thereof. For example, the network 400 can include a cable network, a wired network, a fiber optic network, a telecommunication network, an intranet, the Internet, a local area network (LAN), a wide area network (WAN), a wireless local area network (WLAN), a metropolitan area network (MAN), a wide area network (WAN), a public switched telephone network (PSTN), a Bluetooth network, a ZigBee network, a near field communication (NFC) network, or a similar network. In some embodiments, the network 400 can include one or more network access points. For example, the network 400 can include a wired or wireless network access point, such as a base station and/or an Internet exchange point. By using these access points, the mobile terminal 100, the first server 201, and the second server 202 can be connected to the network 400 to exchange data and/or information.

The mobile terminal 100 can be an intelligent electronic device of a user 10. In some embodiments, the mobile terminal 100 can include a mobile phone 120-1, a tablet 120-2, a laptop 120-3, a built-in device or similar content of a motor vehicle 120-4, or any combination thereof. In some embodiments, the mobile terminal 100 can include a smartphone, a personal digital assistant (PDA), a game device, a navigation device, a point of sale (POS) device, etc., or any combination thereof. In some embodiments, the intelligent electronic device can include but is not limited to a laptop, a tablet, a smart home device, a wearable device, a virtual reality device, an augmented reality device, etc., or any combination thereof. In some embodiments, the smart home device can include an intelligent lighting device, a control device of an intelligent electrical device, an intelligent walkie talkie, etc., or any combination thereof. In some embodiments, the wearable device can include a smart bracelet, smart shoes, smart glasses, a smart helmet, a smartwatch, smart clothing, a smart backpack, smart accessories, etc., or any combination thereof. In some embodiments, the virtual reality device and/or the augmented reality device can include a virtual reality helmet, virtual reality glasses, a virtual reality patch, an augmented reality helmet, augmented reality glasses, an augmented reality patch, etc., or any combination thereof. For example, the virtual reality device and/or the augmented reality device can include Google glasses, Oculus Rift, HoloLens, and Gear VR.

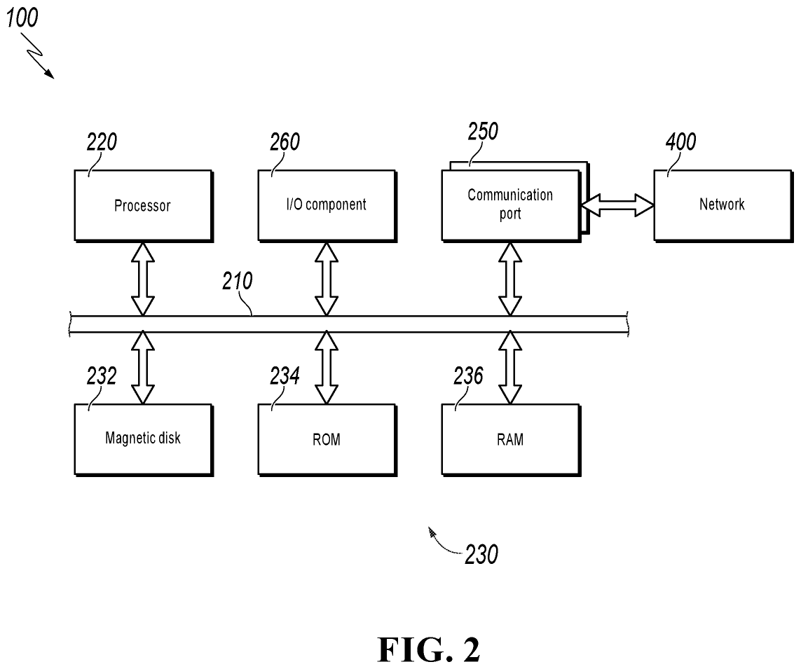

FIG. 2 is a schematic diagram illustrating a hardware structure of a mobile terminal 100, according to some embodiments of the present application.

The mobile terminal 100 includes at least one memory 230 and at least one processor 220. In some embodiments, the mobile terminal 100 can further include a communication port 250 and an internal communication bus 210. In addition, the mobile terminal 100 can further include an I/O component 260.

The internal communication bus 210 can connect different system components, including the memory 230 and the processor 220.

The I/O component 260 supports input/output between the mobile terminal 100 and other components.

The memory 230 can include a data storage apparatus. The data storage apparatus can be a non-temporary storage medium or a temporary storage medium. For example, the data storage apparatus can include one or more of a magnetic disk 232, a read only memory (ROM) 234, or a random access memory (RAM) 236. The memory 230 further includes at least one instruction set stored in the data storage apparatus. The instruction set is computer program code, and the computer program code can include a program, a routine, an object, a component, a data structure, a process, a module, etc. for performing the data processing methods provided in the present application.

The communication port 250 is used for data communication between the mobile terminal 100 and the outside world. For example, the mobile terminal 100 can connect to a network 400 by using the communication port 250, and then send a translation request to a first server 201.

The at least one processor 220 communicates with the at least one memory 230 by using the internal communication bus 210. The at least one processor 220 is configured to execute the at least one instruction set. When the at least one processor 220 executes the at least one instruction set, the mobile terminal 100 performs the data processing methods provided in the present application. The processor 220 can perform some or all of the steps included in the data processing methods. The processor 220 can be in a form of one or more processors. In some embodiments, the processor 220 can include one or more hardware processors, such as microcontrollers, microprocessors, reduced instruction set computers (RISC), application-specific integrated circuits (ASIC), application-specific instruction set processors (ASIP), central processing units (CPU), graphics processing units (GPU), physical processing units (PPU), microcontroller units, digital signal processors (DSP), field programmable gate arrays (FPGA), advanced RISC machines (ARM), programmable logic devices (PLD), any circuit or processor that can perform one or more functions, or any combination thereof. For illustration only, only one processor 220 is described in the mobile terminal 100 in the present application. However, it is worthwhile to note that the mobile terminal 100 in the present application can also include a plurality of processors. Therefore, the operations and/or method steps disclosed in the present application can be performed by one processor as described in the present application, or by a plurality of processors jointly. For example, if the processor 220 of the mobile terminal 100 performs steps A and B in the present application, it should be understood that steps A and B can also be performed jointly or separately by two different processors 220 (for example, a first processor performs step A, and a second processor performs step B, or the first processor and the second processor jointly perform steps A and B).

At least one program can be loaded in the mobile terminal 100. The program can include computer program code. The computer program code can include but is not limited to a program, a routine, an object, a component, a data structure, a process, a module, etc.

In some embodiments, the at least one program can include a first program. In some embodiments, the first program can be an open platform. By making an application programming interface (API) or a function of the open platform public, the open platform enables external programs to increase functions of the open platform or use resources of the open platform, without changing source code of the open platform. The second program can access the open platform by using the public API or function of the open platform. The open platform can provide a runtime environment for running the second program. That is, after the second program accesses the open platform, the runtime of the open platform can run code of the second program. As an example, the open platform can include but is not limited to a digital life open platform, a social open platform, a shopping open platform, a game open platform, a content platform, etc. The external programs are programs outside the open platform. As an example, the external programs can include but are not limited to mobile applications, website applications, public accounts, third-party platforms, etc., which are outside the open platform.

For distinguishing, in the following description of the present application, the “second program” is used to indicate an external program that accesses the open platform by using the public API or function. The second program can be developed based on the first program. For example, the open platform can be XX social software, and the second program can be an applet or H5 that is developed based on an environment of the XX social software and that accesses the XX social software. For another example, the open platform can be XX payment software, and the second program can be a merchant or service applet that is developed based on the XX payment software and that accesses the XX payment software.

In some embodiments, the first program can include a native application (native APP for short). The native APP can run based on a local operating system. In some embodiments, the second program can include a web application (web APP for short) developed based on the native APP. The web APP can be run based on a browser.

The first program can be connected to the first server 201. A back end of the first program can be installed in the first server 201. A hardware structure of the first server 201 can be the same as or similar to the hardware structure shown in FIG. 2. Details are omitted here for simplicity.

The first server 201 can provide a service for a user by using the first program. The first program can provide a user with a capability and a page for interacting with the first server 201 by using the network 400. In some embodiments, the first program can display a human-computer interaction interface for the user. The human-computer interaction interface can be a web page. The human-computer interaction interface can be displayed on a screen of the mobile terminal 100. In some embodiments, the human-computer interaction interface includes copywriting content displayed in a form of text or pictures. In some embodiments, the first program can download the copywriting content from the first server 201. In some embodiments, the first program can obtain the copywriting content from the memory of the mobile terminal 100 that the first program is loaded in.

The second program can be connected to the second server 202. A back end of the second program can be installed in the second server 202. A hardware structure of the second server 202 can be the same as or similar to the hardware structure shown in FIG. 2. Details are omitted here for simplicity.

The second server 202 can provide a service for a user by using the second program. The second program can provide a user with a capability and a page for interacting with the second server 202 by using the network 400. In some embodiments, the second program can display a human-computer interaction interface for the user. The human-computer interaction interface can be a web page. The human-computer interaction interface can be displayed on the screen of the mobile terminal 100. In some embodiments, the human-computer interaction interface includes copywriting content displayed in a form of text or pictures. In some embodiments, the second program can download the copywriting content from the second server 202.

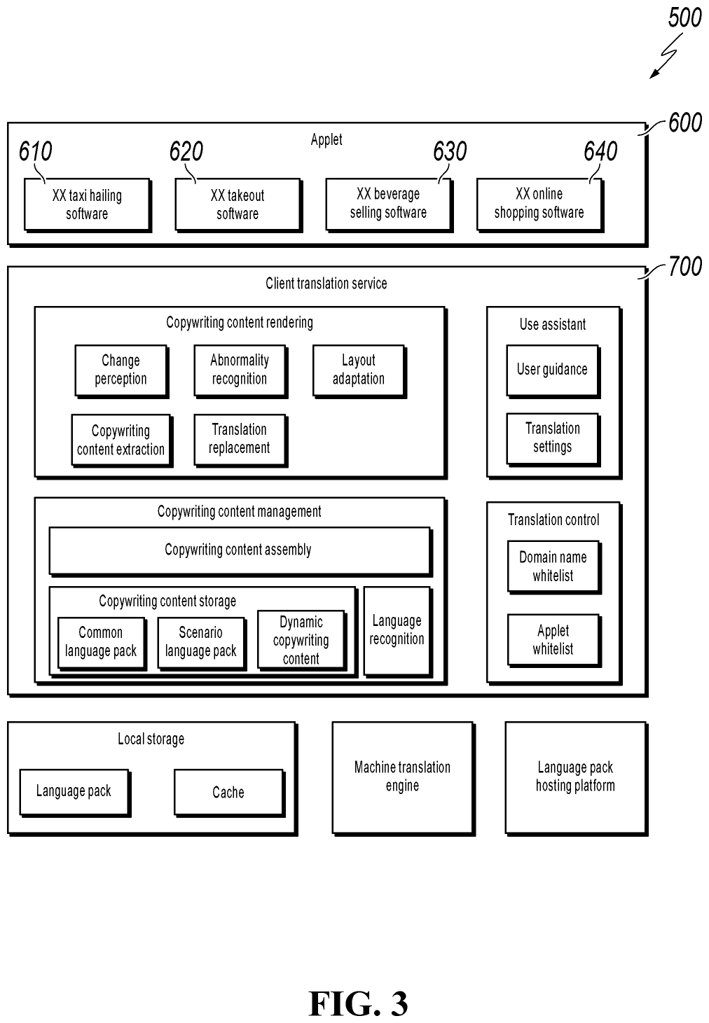

As an example, FIG. 3 is a system block diagram illustrating an open platform 500, according to some embodiments of the present application. Specifically, the open platform 500 can include an external program access module 600 and a data processing component 700.

The external program access module 600 includes at least one first interface. The first interface is configured to enable programs outside the open platform 500 to access the open platform 500. For example, in the open platform 500 shown in FIG. 3, external programs can include but are not limited to XX taxi hailing software 610, XX takeout software 620, XX beverage selling software 630, XX online shopping software 640, etc., which access the open platform 500 by using the first interface. In some embodiments, the first interface can include some predefined functions. In some embodiments, the first interface can include an agreement on mutual connection between software.

A program installed in the mobile terminal 100 can interact with a user by loading a human-computer interaction interface. For example, the program can capture user input by using the human-computer interaction interface. The program can further provide a service or display content for the user by using the human-computer interaction interface. The human-computer interaction interface can include at least one piece of copywriting content. The copywriting content can include static copywriting content, dynamic copywriting content, and/or third-party page copywriting content.

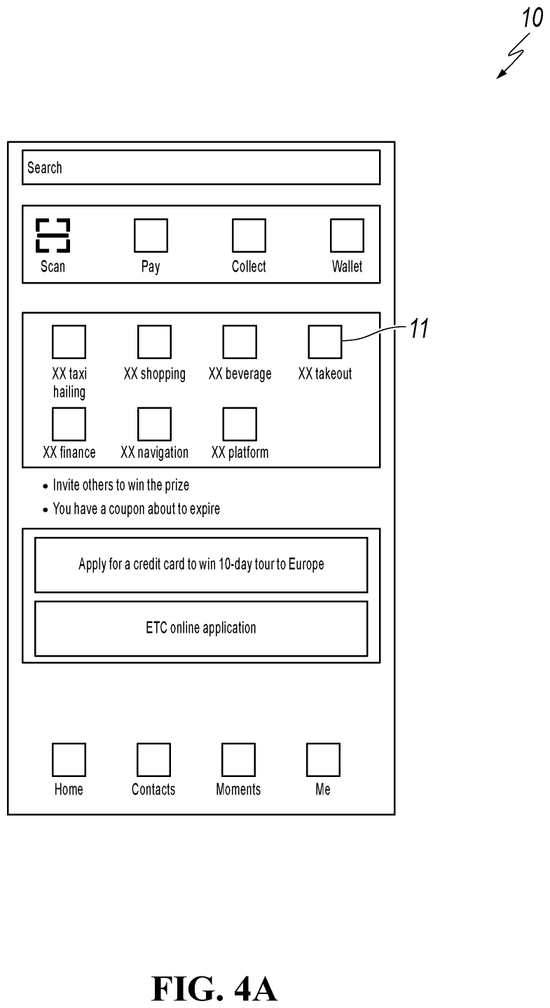

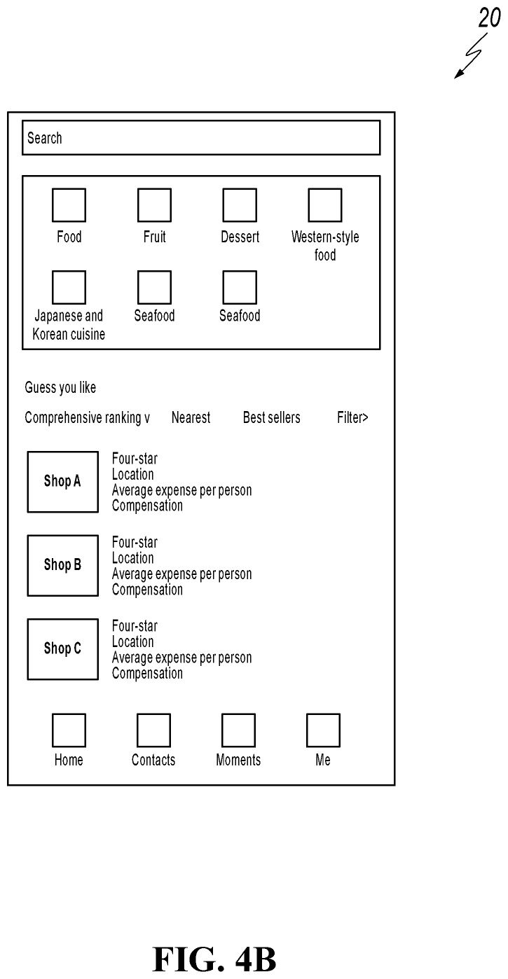

As an example, FIG. 4A illustrates an interface 10 displayed by a first program loaded in a mobile terminal 100, according to some embodiments of the present application. A user can enter the interface 10 by tapping on an icon of the first program on a display (for example, a screen) of the mobile terminal 100. An icon 11 of a second program is displayed on the interface 10. When the user taps on the icon 11 on the interface 10, the interface 10 switches to an interface of the second program. In this process, the mobile terminal 100 calls and runs the second program by using a first interface. As an example, FIG. 4B illustrates an interface 20 of a second program, according to some embodiments of the present application.

With the economic globalization, multi-language is a problem that needs to be handled for programs installed in a mobile terminal 100. Multi-language means that when displaying a human-computer interaction interface, a program in the mobile terminal 100 can display copywriting content on the human-computer interaction interface in different languages as needed by a user.

Using the interface 10 shown in FIG. 4A as an example, a default display language of the interface 10 can be Chinese. If the user expects the interface 10 to be displayed in English, the mobile terminal 100 can convert the interface 10 to an interface displayed in English.

There are many solutions for implementing multi-language for human-computer interaction interfaces loaded by internal programs of an open platform 500. However, there is no good solution for implementing multi-language for an interface (such as the interface 20 shown in FIG. 4B) of an external program (that is, the second program) that accesses the open platform 500.

An open platform 500 provided in the present application can implement multi-language for an external program (that is, a second program) that accesses the open platform 500.

The open platform 500 provided in the present application implements multi-language for the second program by using a data processing component 700.

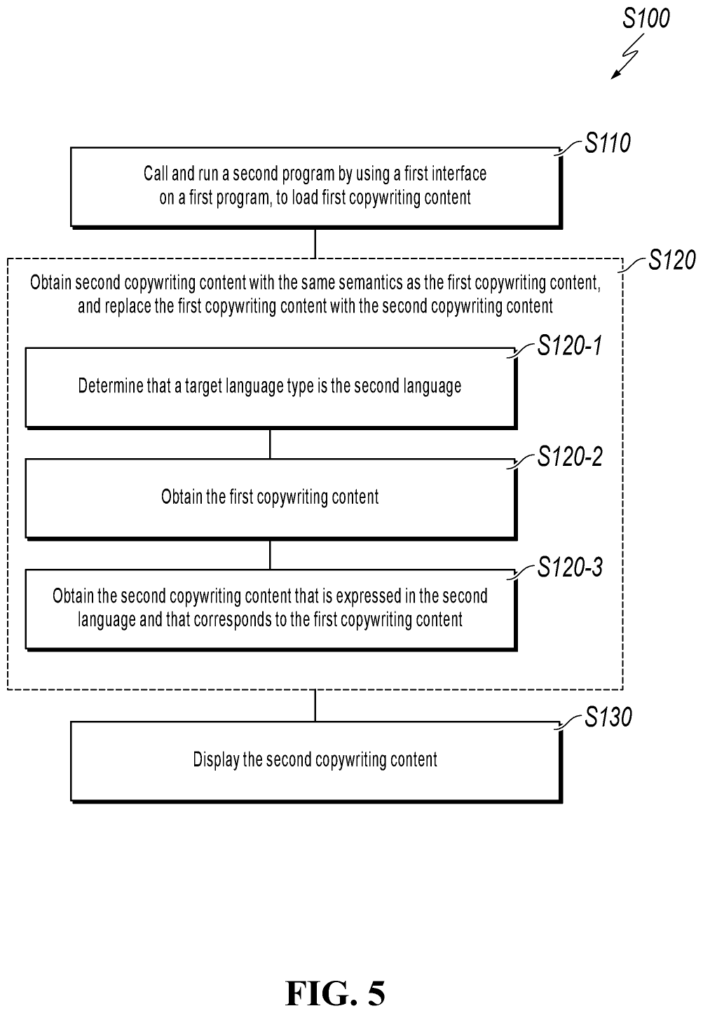

The present application further provides a data processing method. The data processing method can be used to convert copywriting content on an interface displayed by an external program that accesses the open platform 500 from a first language to a second language. FIG. 5 is a flowchart illustrating a data processing method S100, according to some embodiments of the present application.

The procedure S100 can be stored as at least one instruction set in a non-temporary storage medium (such as a memory 230) in a mobile terminal 100 for data processing. At least one processor 220 is communicably coupled to the at least one non-temporary storage medium. When the mobile terminal 100 is running, the at least one processor 220 reads the at least one instruction set, and performs steps in the procedure S100 according to instructions of the at least one instruction set.

Operations of the procedure S100 shown below are intended to be illustrative rather than restrictive. In some embodiments, the procedure S100 can be implemented by adding one or more additional operations not described and/or removing one or more operations described here. In addition, an order of operations shown in FIG. 5 and described below does not constitute a limitation.

S110: Call and run a second program by using a first interface on a first program, to load first copywriting content.

As an example, the first program is a main application running on the mobile terminal 100 and is connected to a first server 201. For example, the first program can be the open platform 500 shown in FIG. 3.

As an example, the second program is an external application that is developed based on the first program and that accesses the first program by using the first interface. The second program is connected to a second server 202 and downloads the first copywriting content from the second server 202. For example, the second program can be an applet or H5 that accesses the open platform 500. For ease of description, in the following description of the present application, functions of the second program are described by using an applet as an example.

In some embodiments, the first copywriting content is expressed in a first form.

In some embodiments, the first form can include a text expression in a first language. For example, the first copywriting content can be displayed in a form of text in Chinese.

In some embodiments, the first form can include an audio expression in a first language. For example, the first copywriting content can be displayed in a form of audio in Chinese.

For ease of description, in the following description of the present application, content of an expression form (that is, the first form) of the first copywriting content is described by using the “text expression in the first language” as an example.

S120: Obtain second copywriting content with the same semantics as the first copywriting content, and replace the first copywriting content with the second copywriting content.

In some embodiments, the second copywriting content is expressed in a second form.

In some embodiments, the second form can include a text expression in a second language. For example, the second copywriting content can be displayed in a form of text in English.

In some embodiments, the second form can include an audio expression in a second language. For example, the second copywriting content can be displayed in a form of audio in English.

For ease of description, in the following description of the present application, content of an expression form (that is, the second form) of the second copywriting content is described by using the “text expression in the second language” as an example.

In some embodiments, the obtaining second copywriting content with the same semantics as the first copywriting content and replacing the first copywriting content with the second copywriting content can include steps S120-1, S120-2, and S120-3.

S120-1: Determine that a target language type is the second language.

In some embodiments, the mobile terminal can determine, based on language setting information of the first program, that the target language type is the second language.

In some embodiments, the mobile terminal can determine, based on language setting information of the mobile terminal, that the target language type is the second language.

In some embodiments, the mobile terminal can determine, based on location information of the mobile terminal, that the target language type is the second language.

S120-2: Obtain the first copywriting content.

In some embodiments, when a user enables an applet that accesses the open platform 500, the applet requests to obtain data of a current page. The data of the current page includes the first copywriting content displayed in the first language. The applet instructs a rendering engine to draw the data of the current page into a current interface to be displayed on a display. The current interface includes the first copywriting content displayed in the first language. The applet notifies a data processing component 700 that the page data has been loaded. The data processing component 700 captures the first copywriting content displayed in the first language on the current interface.

In some embodiments, the data processing component 700 can monitor changes in content on the applet page. When the user enables the applet, the open platform 500 is triggered to start a monitoring service provided by the data processing component 700 for page copywriting content changes. When the current page data loaded by the applet is updated, the data processing component 700 captures content that needs to be translated in the current page data, that is, first copywriting content written in the first language. Using a takeout applet as an example, when the user taps on a certain icon on an interface of the applet to limit a scope of recommended takeout businesses to a certain area, content of businesses on the interface displayed by the applet is to be updated, that is, the current page data is to be updated. For another example, when the user enters a comment for a certain business by using the interface displayed by the takeout applet and taps on OK, the interface that is displayed by the applet and that includes user comments is to be changed, and the current page data is also to be updated.

In some embodiments, the data processing component 700 traverses all nodes in the current page data, and obtains characters written in the first language in the nodes. The characters written in the first language are the first text.

In some embodiments, the data processing component 700 marks translated copywriting content in a previous page. When obtaining copywriting content that needs to be translated in the current page data, the data processing component 700 filters out these marked copywriting content and only configures updated copywriting content as copywriting content that needs to be translated, that is, the first copywriting content. Using a takeout applet as an example, when the user taps on a certain icon on an interface of the applet to limit a scope of recommended takeout businesses to a certain area, content of recommended businesses on the interface displayed by the applet is to be updated. However, some copywriting content on the interface of the applet may not change, such as setting icon copywriting content, copywriting content of a food type, and indication copywriting content in input boxes on the interface of the applet. In this case, the data processing component 700 obtains, through screening, the updated copywriting content from the current page data as the copywriting content that needs to be translated, for example, updated business recommendation content.

S120-3: Obtain the second copywriting content that is expressed in the second language and that corresponds to the first copywriting content.

In some embodiments, the mobile terminal can query and obtain the second copywriting content from at least one memory of the mobile terminal.

In some embodiments, a target language pack is stored in the at least one memory, and the mobile terminal can query and obtain the second copywriting content from the target language pack.

In some embodiments, the mobile terminal can translate the first copywriting content by using a target machine translation engine.

In some embodiments, after obtaining the first copywriting content that needs to be translated, the data processing component 700 first queries whether there is second copywriting content with the same semantics as the first copywriting content in a cache of the mobile terminal. If yes, the data processing component 700 replaces the queried second copywriting content with the first copywriting content. After that, the data processing component 700 determines whether all copywriting content that needs to be translated has been translated. If there is untranslated copywriting content, the data processing component 700 queries second copywriting content corresponding to the untranslated first copywriting content from a local language pack. In some embodiments, before this, the data processing component 700 can further request to obtain a latest language pack from a language pack hosting platform. After that, the data processing component 700 determines whether all copywriting content that needs to be translated has been translated. If there is untranslated copywriting content, the data processing component 700 sends the untranslated first copywriting content to the machine translation engine and requests the machine translation to translate the first copywriting content. At this point, all first copywriting content that needs to be translated has been translated.

In some embodiments, the data processing component 700 can further store the second copywriting content obtained from the translation engine into at least one memory (such as the cache) of the mobile terminal. As such, the data processing component 700 can find the translation directly from the cache during next translation.

S130: Display the second copywriting content.

According to the previous description, the data processing component 700 obtains the translation of all first copywriting content that needs to be translated, that is, the second copywriting content. The data processing component 700 replaces the first copywriting content in the current page data with the second copywriting content, and then draws a new human-computer interaction interface based on current page data obtained after the replacement. The copywriting content displayed on the new human-computer interaction interface is the second copywriting content written in the second language.

In some embodiments, the open platform 500 can further include at least one second interface. Before the applet needs to load the human-computer interaction interface, the second interface can be used to call and run the data processing component 700 to replace the first copywriting content in the loaded current page data with the second copywriting content. After that, the applet instructs the rendering engine to directly load page data obtained after translation replacement to the display of the mobile terminal. As such, the copywriting content on the interface that the user directly views is the copywriting content written in the second language, thereby preventing the user from being disturbed by switching between interfaces in different languages.

As such, the mobile terminal 100 converts the copywriting content on the interface displayed by the applet that accesses the open platform 500 from the first language to the second language by using the data processing component 700 in the open platform 500, thereby implementing multi-language for the external program that accesses the open platform 500.

In conclusion, the present application provides data processing methods, open platforms, and mobile terminals installed with the open platforms. The open platform includes at least one first interface. The open platform can call and run a second program by using the at least one first interface. The open platform further includes a data processing component. When the second program is running, the data processing component can obtain first copywriting content that is expressed in a first form and that is loaded by the second program, obtain second copywriting content with the same semantics as the first copywriting content, and replace the first copywriting content with the second copywriting content, where the second copywriting content is expressed in a second form. The data processing component can obtain the second copywriting content from a local cache of the mobile terminal, a language pack, or a machine translation engine.

The data processing methods in the present application are used to implement multi-language for external applets and/or H5 pages, and development costs of developers on the applets and/or the H5 pages are low. A data processing component 700 can be used to translate applets and/or H5 pages, and can support translation of all applets and H5 pages. Merchants basically do not need to invest in multi-language development and operation and maintenance.

According to the data processing methods in the present application, for an update of static copywriting content, only the language pack needs to be updated. For dynamic long copywriting content, machine translation can be called. As such, investment in multi-language development for applets and/or H5 is reduced. For short copywriting content, a local cache or a language pack is directly used to implement translation, thereby avoiding a problem of low translation accuracy of machine translation for the short copywriting content.

According to the data processing methods in the present application, a data processing apparatus is integrated in a front end (that is, a mobile terminal side) of an open platform, and both extraction and replacement of copywriting content are performed on the front end side. Therefore, if a language type needs to be changed or a local language pack needs to be updated, the data processing apparatus only needs to request a server to update the language pack, and release is not needed, thereby reducing development costs. The data processing component in the present application can sense a copywriting content change and respond to the copywriting content change in time to trigger translation. According to the data processing methods in the present application, language packs and machine translation are combined, and advantages of the language packs and machine translation are used to solve the translation accuracy problem. According to the data processing methods in the present application, a hybrid mode is used, advantages of the front end and a native end are combined, and a translation speed and accuracy are well guaranteed, thereby improving performance experience of using applets/H5.

To sum up, after reading the detailed disclosure, a person skilled in the art can understand that the previous detailed disclosure can be presented by way of example only, and cannot be restrictive. Although it is not clearly stated here, it can be understood by a person skilled in the art that the present application is intended to include various reasonable changes, improvements, and modifications to the embodiments. These changes, improvements, and modifications are intended to be made by the present application and fall within the spirit and scope of the example embodiments of the present application.

In addition, certain terms in the present application have been used to describe the embodiments of the present application. For example, “an embodiment”, “embodiments”, and/or “some embodiments” mean that the specific features, structures, or characteristics described with reference to the embodiment can be included in at least one embodiment of the present application. Therefore, it can be emphasized and understood that two or more references to “embodiments”, “an embodiment”, or “an alternative embodiment” in various parts of the present specification do not necessarily refer to the same embodiment. In addition, specific features, structures, or characteristics can be appropriately combined in one or more embodiments of the present application.

It should be understood that in the previous description of the embodiments of the present application, to help understand a feature, the present application sometimes combines various features in a single embodiment, a single drawing, or the description thereof for the purpose of simplifying the present application. Alternatively, the present application disperses various features in a plurality of embodiments of the present application. However, this does not mean that the combination of these features is necessary, and it is entirely possible for a person skilled in the art to extract some of the features as a separate embodiment when reading the present application. That is, the embodiment in the present application can also be understood as the integration of a plurality of sub-embodiments. It is also true that the content of each sub-embodiment is less than all features of a single embodiment disclosed above.

In some implementation solutions, numbers expressing the quantities or properties used to describe and claim protection of some implementation solutions of the present application should be understood to be modified in some cases by the terms “about”, “approximately”, or “substantially”. For example, unless otherwise stated, “about”, “approximately”, or “substantially” can indicate ±20% variations of the described values. Therefore, in some implementation solutions, the numerical parameters listed in the written description and the appended claims are approximate values, which can vary based on the desired properties that a particular implementation solution attempts to obtain. In some implementation solutions, the numerical parameters should be interpreted based on the reported quantity of significant digits and by using a common rounding technique. Although the numerical ranges and parameters in a wide range that are listed in some implementation solutions of the present application are approximate values, the specific embodiments list the values as accurate as possible.

Each patent, patent application, patent application publication, and other materials such as articles, books, specifications, publications, documents, and goods cited in the present specification can be incorporated here by reference. All content used for all purposes, except for any related litigation document history, any same litigation document history that may be inconsistent with or conflict with the present specification, or any same litigation document history that may have a restrictive effect on the widest scope of the claims, is currently associated with the present specification or is to be associated with the present specification later. For example, if there is any inconsistency or conflict between the description, definition, and/or use of terms associated with any included materials and the description, definition, and/or use of terms in the present specification, the terms in the present specification shall prevail.

Finally, it should be understood that the disclosed implementation solutions of the present application are illustration of the principles of the implementation solutions of the present application. Other modified embodiments also fall within the scope of the present application. Therefore, the embodiments disclosed in the present application are merely examples but not limitations. A person skilled in the art can use alternative configurations according to the embodiments in the present application to implement the application in the present application. Therefore, the embodiments of the present application are not limited to the embodiments precisely described in the present application.

1. A computer-implemented method for copywriting content processing, comprising:
loading a first copywriting content expressed in a first form by calling a second computer program using a first interface of a first computer program, wherein the first computer program is installed on a mobile terminal and connected to a first server, and the second computer program accesses the first computer program using the first interface, and is connected to a second server, and wherein the second computer program downloads the first copywriting content from the second server;
determining whether the first copywriting content is static or dynamic by monitoring and comparing the first copywriting content at two predetermined time points;
obtaining a second copywriting content with same semantics as the first copywriting content based on the determination;
replacing the first copywriting content with the second copywriting content, wherein the second copywriting content is expressed in a second form; and
presenting the second copywriting content for display on the mobile terminal.

2. The computer-implemented method according to claim 1, wherein the first form comprises a first language, and the second form comprises a second language; and
wherein the computer-implemented method further comprises determining the first copywriting content by filtering out one or more copywriting contents from a plurality of copywriting contents on a display of a mobile terminal, wherein the one or more copywriting contents are in the second language; and
presenting the second copywriting content comprises displaying, by the mobile terminal, the second copywriting content in the second language on the display of the mobile terminal.

3. The computer-implemented method according to claim 2, wherein obtaining the second copywriting content with the same semantics as the first copywriting content comprises:
determining that a target language is the second language;
obtaining the first copywriting content; and
obtaining the second copywriting content that is expressed in the second language and corresponds to the first copywriting content.

4. The computer-implemented method according to claim 3, wherein determining that the target language is the second language is based on one of language setting information of the first computer program, language setting information of the mobile terminal, or location information of the mobile terminal.

5. The computer-implemented method according to claim 3, wherein obtaining the second copywriting content that is expressed in the second language and corresponds to the first copywriting content comprises: in response to determining that the first copywriting content is static, querying and obtaining, from a memory of the mobile terminal, the second copywriting content.

6. The computer-implemented method according to claim 5, wherein a target language pack is stored in the memory, and
querying and obtaining, from the memory of the mobile terminal, the second copywriting content comprises querying and obtaining, from the target language pack, the second copywriting content.

7. The computer-implemented method according to claim 6, further comprising:
requesting to obtain the target language pack from a hosting platform; and
receiving the target language pack from the hosting platform.

8. The computer-implemented method according to claim 3, wherein the obtaining the second copywriting content that is expressed in the second language and that corresponds to the first copywriting content comprises:
in response to determining that that the first copywriting content is dynamic,
requesting a machine translation engine to translate the first copywriting content; and
receiving, from the machine translation engine, the second copywriting content.

9. The computer-implemented method according to claim 8, further comprising storing the second copywriting content in a memory of the mobile terminal.

10. The computer-implemented method according to claim 1, wherein the first form comprises an audio expression in a first language, and the second form comprises an audio expressed in a second language; and
presenting the second copywriting content comprises playing, by the mobile terminal, the second copywriting content in an audio form in the second language on the mobile terminal.

11. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
loading a first copywriting content expressed in a first form by calling a second computer program using a first interface of a first computer program, wherein the first computer program is installed on a mobile terminal and connected to a first server, and the second computer program accesses the first computer program using the first interface, and is connected to a second server, and wherein the second computer program downloads the first copywriting content from the second server;
determining whether the first copywriting content is static or dynamic by monitoring and comparing the first copywriting content at two predetermined time points;
obtaining a second copywriting content with same semantics as the first copywriting content based on the determination;
replacing the first copywriting content with the second copywriting content, wherein the second copywriting content is expressed in a second form; and
presenting the second copywriting content for display on the mobile terminal.

12. The computer-implemented system according to claim 11, wherein the first form comprises a first language, and the second form comprises a second language;
wherein the one or more operations further comprise determining the first copywriting content by filtering out one or more copywriting contents from a plurality of copywriting contents on a display of a mobile terminal, wherein the one or more copywriting contents are in the second language; and
and
presenting the second copywriting content comprises displaying, by the mobile terminal, the second copywriting content in the second language on the display of the mobile terminal.

13. The computer-implemented system according to claim 12, wherein obtaining the second copywriting content with the same semantics as the first copywriting content comprises:
determining that a target language is the second language;
obtaining the first copywriting content; and
obtaining the second copywriting content that is expressed in the second language and corresponds to the first copywriting content.

14. The computer-implemented system according to claim 13, wherein determining that the target language is the second language is based on one of language setting information of the first computer program, language setting information of the mobile terminal, or location information of the mobile terminal.

15. The computer-implemented system according to claim 13, wherein obtaining the second copywriting content that is expressed in the second language and corresponds to the first copywriting content comprises: in response to determining that the first copywriting content is static, querying and obtaining, from a memory of the mobile terminal, the second copywriting content.

16. The computer-implemented system according to claim 15, wherein a target language pack is stored in the memory, and
querying and obtaining, from the memory of the mobile terminal, the second copywriting content comprises querying and obtaining, from the target language pack, the second copywriting content.

17. The computer-implemented system according to claim 16, wherein the operations further comprise:
requesting to obtain the target language pack from a hosting platform; and
receiving the target language pack from the hosting platform.

18. The computer-implemented system according to claim 13, wherein obtaining the second copywriting content that is expressed in the second language and that corresponds to the first copywriting content comprises:
in response to determining that that the first copywriting content is dynamic,
requesting a machine translation engine to translate the first copywriting content; and
receiving, from the machine translation engine, the second copywriting content.

19. The computer-implemented system according to claim 18, wherein the operations further comprise storing the second copywriting content in a memory of the mobile terminal.

20. A non-transitory, computer-readable medium storing one or more instructions executable by a computer system to perform operations comprising:
loading a first copywriting content expressed in a first form by calling a second computer program using a first interface of a first computer program, wherein the first computer program is installed on a mobile terminal and connected to a first server, and the second computer program accesses the first computer program using the first interface, and is connected to a second server, and wherein the second computer program downloads the first copywriting content from the second server;
determining whether the first copywriting content is static or dynamic by monitoring and comparing the first copywriting content at two predetermined time points;
obtaining a second copywriting content with same semantics as the first copywriting content based on the determination;
replacing the first copywriting content with the second copywriting content, wherein the second copywriting content is expressed in a second form; and
presenting the second copywriting content for display on the mobile terminal.
